(19) United States
(12) Patent Application Publication
(10) Pub. No.: US 2011/0208939 A1
(43) Pub. Date: Aug. 25, 2011

(54) MEMORY ACCESS SYSTEM AND MEMORY ACCESS CONTROL METHOD

(75) Inventor: Tetsuro TAKIZAWA, Kanagawa (JP)

(73) Assignee: Renesas Electronics Corporation

(21) Appl. No.: 13/032,383

(22) Filed: Feb. 22, 2011

(30) Foreign Application Priority Data
Feb. 24, 2010 (JP) 2010-38895

(51) Int. Cl. G06F 12/00

(52) U.S. Cl. 711/167; 711/E12.001

(57) ABSTRACT

The memory access system includes first to fourth memories and a memory controller. The memory controller accesses blocks in a first block group respectively stored in the first and second memories by supplying the first and second unique addresses different from each other at a first timing of activating a first chip select signal, and accesses blocks in a second block group respectively stored in the third and fourth memories by supplying the first and second unique addresses different from each other at a second timing of activating a second chip select signal.

### CROSS-REFERENCE TO RELATED APPLICATIONS

This application is based upon and claims the benefit of priority from Japanese patent application No. 2010-038895, filed on Feb. 24, 2010, the disclosure of which is incorporated herein in its entirety by reference.

### BACKGROUND

The present invention relates to a memory access system and a memory access control method and, particularly, to a memory access system and a memory access control method that store data arranged in a two-dimensional array into a plurality of memories.

There is a technique that stores two-dimensional array data such as image data into a plurality of memories. FIG. 10 is a block diagram to explain a memory access system according to related art. The memory access system shown in FIG. 10 includes a memory controller 101, a memory A (110), and a memory B (120). The memory controller 101 is connected to the memory A (110) and the memory B (120). The memory controller 101 supplies a common address (AD) to the memory A (110) and the memory B (120). The memory A (110) includes an address decoder A (111), a storage area A (112), an interface A (113), and a bus 114. Likewise, the memory B (120) includes an address decoder B (121), a storage area B (122), an interface B (123), and a bus 124. Further, a processor 102 and a decoder 103 are connected to the memory controller 101 through a common bus 104.

When the decoder 103 accesses data stored in the memory A (110) and the memory B (120), the decoder 103 outputs coordinates (X, Y) of the two-dimensional array of data which it intends to access to the memory controller 101 through the common bus 104. Receiving the coordinates (X, Y) of the two-dimensional array from the decoder 103, the memory controller 101 outputs an address (AD) of the data corresponding to the coordinates to the address decoder A (111) and the address decoder B (121) of the memory A (110) and the memory B (120), respectively.

The address decoder A (111) receives the address (AD) from the memory controller 101 and outputs an address corresponding to the address (AD) to the storage area A (112). In response to the address from the address decoder A (111), the storage area A (112) outputs data to the memory controller 101 through the bus 114 and the interface A (113). Likewise, the address decoder B (121) receives the address (AD) from the memory controller 101 and outputs an address corresponding to the address (AD) to the storage area B (122). In response to the address from the address decoder B (121), the storage area B (122) outputs data to the memory controller 101 through the bus 124 and the interface B (123).

FIG. 11 is a timing chart to explain an operation of the memory access system shown in FIG. 10. In the memory access system shown in FIG. 10, bus widths of data output from the memory A (110) and data output from the memory B (120) are both 16 bits. Further, a bus width after the data output from the memory A (110) and the data output memory B (120) have merged is 32 bits. As shown in T100 to T101 of FIG. 11, in the memory access system shown in FIG. 10, the 32-bit width data that combines the 16-bit width data from the memory A (110) and the 16-bit width data from the memory B (120) is output for eight clocks (eight bursts), so that 256-bit data is output. In the memory access system shown in FIG. 10, T100 to T101 is a minimum access unit (256 bits). The same applies to T101 to T102.

The data obtained in this manner is output from the memory controller 101 to the decoder 103 through the common bus 104. The minimum access unit of the memory A and the memory B is 256 bits. Thus, if it is assumed that the bus width of the common bus 104 is 32 bits, for example, the memory controller 101 divides the 256-bit data into eight segments (each having 32 bits) in order that the data width corresponds to the bus width of the common bus 104 and then outputs the divided data to the decoder 103. In this case, because 32-bit data each is output eight times, the memory controller 101 occupies the common bus 104 during this period of time. Therefore, the processor 102, for example, cannot use the common bus 104 during the period of time.

Increasing the minimum access unit (256 bits) of the memory enables a memory access speed to increase. However, increasing the minimum access unit causes unnecessary data different from desired data to be accessed at the same time. As a result, the common bus 104 is occupied by unnecessary data, which decreases the efficiency of the entire system.

International Patent Publication No. WO2008/010599 discloses a technique to address such an issue. FIG. 12 is a block diagram to explain the memory access system disclosed in WO2008/010599. The memory access system shown in FIG. 12 includes a memory controller 201, a memory A (210) and a memory B (220). The memory controller 201 is connected to the memory A (210) and the memory B (220). Further, a processor 202 and a decoder 203 are connected to the memory controller 201 through a common bus 204.

The memory controller 201 supplies a common address (AD) to the memory A (210) and the memory B (220). Further, the memory controller 201 outputs a low-order 2-bit unique address (ADA) to the memory A (210). Also, the memory controller 201 outputs a low-order 2-bit unique address (ADB) to the memory B (220). The memory A (210) includes an address decoder A (211), a storage area A (212), an interface A (213), and a bus 214. Likewise, the memory B (220) includes an address decoder B (221), a storage area B (222), an interface B (223), and a bus 224.

FIG. 13 is a view showing image data mapping information of the memory access system disclosed in International Patent Publication No. WO2008/010599. In the memory access system shown in FIG. 12, image data is mapped as shown in FIG. 13, and an address is designated by using the low-order 2-bit unique addresses (ADA, ADB), thereby accessing two rows of data by one access. Specifically, in the memory access system shown in FIG. 12, by setting ADA=0 and ADB=1, access can be made to data in the first row (0, 0) and in the second row (0, 1). Further, by setting ADA=1 and ADB=0, access can be made to data in the first row (1, 0) and in the second row (1, 1). Further, by setting ADA=2 and ADB=3, access can be made to data in the third row (1, 2) and in the fourth row (1, 3). Further, by setting ADA=3 and ADB=2, access can be made to data in the third row (0, 2) and in the fourth row (0, 3).

The operation of the memory access system shown in FIG. 12 is basically the same as the operation of the memory access system shown in FIGS. 10 and 11. However, the memory access system shown in FIG. 12 performs mapping of image data as shown in FIG. 13 and designates an address using the low-order 2-bit unique addresses (ADA, ADB), thereby enabling access to two rows of data by one access.

FIGS. 14A and 14B are views to make comparison between the case of accessing two-dimensional array image data 301 using the memory access system shown in FIG. 10 and the case of accessing the two-dimensional array image data 301 using the memory access system shown in FIG. 12. FIG. 14A shows the case of accessing the two-dimensional array image data 301 using the memory access system shown in FIG. 10, and FIG. 14B shows the case of accessing the two-dimensional array image data 301 using the memory access system shown in FIG. 12. In the example shown in FIGS. 14A and 14B, the minimum access unit is 256 bits (a block indicated by the full line, which is a minimum access unit 302 in FIG. 14A and a minimum access unit 303 in FIG. 14B), and it corresponds to 32 pixels. Further, it is assumed that the two-dimensional array image data 301 is 9 pixels×3 rows.

In the memory access system shown in FIG. 10, data of 32 pixels×1 row is the minimum access unit 302 as shown in FIG. 14A, and therefore six times of memory access are required when accessing the two-dimensional array image data 301 of 9 pixels×3 rows. On the other hand, in the memory access system shown in FIG. 12, data of 16 pixels×2 rows is the minimum access unit 303 as shown in FIG. 14B. Specifically, data in the first row of the two-dimensional array image data 301 is stored in the first row of the minimum access unit 303, and data in the second row of the two-dimensional array image data 301 is stored in the second row of the minimum access unit 303. Therefore, the number of times of memory access when accessing the two-dimensional array image data 301 of 9 pixels×3 rows is reduced to four. Accordingly, by using the memory access system disclosed in International Patent Publication No. WO2008/010599, it is possible to improve the efficiency of memory access.

### SUMMARY

The memory access system according to International Patent Publication No. WO2008/010599 illustrated in FIG. 12 performs mapping of image data as shown in FIG. 13 and designates an address using the low-order 2-bit unique addresses (ADA, ADB), thereby enabling access to two rows of data by one access. This improves the efficiency of memory access.

However, even in the case of using the technique disclosed in International Patent Publication No. WO2008/010599, because memory access is made in eight bursts, the minimum access unit is 128 bits×2 rows (16 pixels×2 rows). Therefore, when the size of data to be access is small, access is made also to unnecessary data at the same time, which decreases the efficiency of memory access.

A first aspect of the present invention is a memory access system that includes first to fourth memories that store two-dimensional array data in units of blocks being a minimum access unit, and a memory controller that controls access to the memories, wherein the memory controller supplies a first chip select signal to the first and second memories, supplies a second chip select signal to the third and fourth memories, supplies a first unique address to the first and third memories, supplies a second unique address to the second and fourth memories, and supplies a common address to the first to fourth memories, the two-dimensional array data is mapped in a given unit of storage, so that the first and second unique addresses of blocks arranged in an X direction are the same, the first and second unique addresses of respective blocks in a first block group arranged in a Y direction and stored in the first and second memories are different from each other, and the first and second unique addresses of respective blocks in a second block group arranged in the Y direction and stored in the third and fourth memories correspond to the first and second unique addresses of the respective blocks in the first block group, and that common addresses of respective blocks in the first and second block groups are the same, and the memory controller accesses blocks in the first block group by supplying the first and second unique addresses different from each other at a first timing of activating the first chip select signal, and accesses blocks in the second block group by supplying the first and second unique addresses different from each other at a second timing of activating the second chip select signal.

In the memory access system according to the first aspect of the present invention, access to the first and second memories and access to the third and fourth memories are performed alternatively using the first and second chip select signals. Further, two-dimensional array data is mapped so that access can be made to blocks in the same column when each of the first and second chip select signals is activated. This enables reduction of the substantial bust length of memory access to half the original length, thereby improving the efficiency of memory access.

A second aspect of the present invention is a memory access control method for accessing first to fourth memories storing two-dimensional array data in units of blocks being a minimum access unit, the method including supplying a first chip select signal to the first and second memories, supplying a second chip select signal to the third and fourth memories, supplying a first unique address to the first and third memories, supplying a second unique address to the second and fourth memories, and supplying a common address to the first to fourth memories, mapping the two-dimensional array data in a given unit of storage, so that the first and second unique addresses of blocks arranged in an X direction are the same, the first and second unique addresses of respective blocks in a first block group arranged in a Y direction and stored in the first and second memories are different from each other, and the first and second unique addresses of respective blocks in a second block group arranged in the Y direction and stored in the third and fourth memories correspond to the first and second unique addresses of the respective blocks in the first block group, and that common addresses of respective blocks in the first and second block groups are the same, accessing blocks in the first block group by supplying the first and second unique addresses different from each other at a first timing of activating the first chip select signal, and accessing blocks in the second block group by supplying the first and second unique addresses different from each other at a second timing of activating the second chip select signal.

In the memory access control method according to the second aspect of the present invention, access to the first and second memories and access to the third and fourth memories are performed alternatively using the first and second chip select signals. Further, two-dimensional array data is mapped so that access can be made to blocks in the same column when each of the first and second chip select signals is activated. This enables reduction of the substantial bust length of memory access to half the original length, thereby improving the efficiency of memory access.

According to the above-described aspects of the present invention, the memory access system and the memory access control method with high access efficiency can be provided.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a memory access system according to a first embodiment;

FIG. 2 is a block diagram showing another example of a memory access system according to the first embodiment;

FIG. 3 is a view showing an example of mapping of two-dimensional array data in the memory access system according to the first embodiment;

FIG. 4 is a timing chart to explain an operation of the memory access system according to the first embodiment (in a case of accessing eight consecutive blocks in the X direction);

FIG. 5 is a timing chart to explain an operation of the memory access system according to the first embodiment (in a case of accessing blocks in eight consecutive rows in the Y direction);

FIG. 6 is a timing chart to explain an operation of the memory access system according to the first embodiment (in a case of accessing blocks in four alternating rows in the Y direction);

FIG. 7 is a timing chart to explain an operation of the memory access system according to the first embodiment (in a case of accessing blocks in four alternating rows in the Y direction);

FIG. 8A is a view showing a case of accessing two-dimensional array image data using the memory access system shown in FIG. 12;

FIG. 8B is a view showing a case of accessing two-dimensional array image data using the memory access system according to the first embodiment;

FIG. 8C is a view to explain the principle of operation of the memory access system according to the first embodiment;

FIG. 9 is a view showing an example of mapping of two-dimensional array data in the memory access system according to a second embodiment;

FIG. 10 is a block diagram to explain a memory access system according to related art;

FIG. 11 is a timing chart to explain an operation of the memory access system according to related art;

FIG. 12 is a block diagram to explain a memory access system disclosed in International Patent Publication No. WO2008/010599;

FIG. 13 is a view showing mapping of image data in the memory access system disclosed in International Patent Publication No. WO2008/010599;

FIG. 14A is a view showing a case of accessing two-dimensional array image data using the memory access system shown in FIG. 10; and

FIG. 14B is a view showing a case of accessing two-dimensional array image data using the memory access system shown in FIG. 12.

### DETAILED DESCRIPTION

### First Embodiment

An embodiment of the present invention is described hereinafter with reference to the drawings.

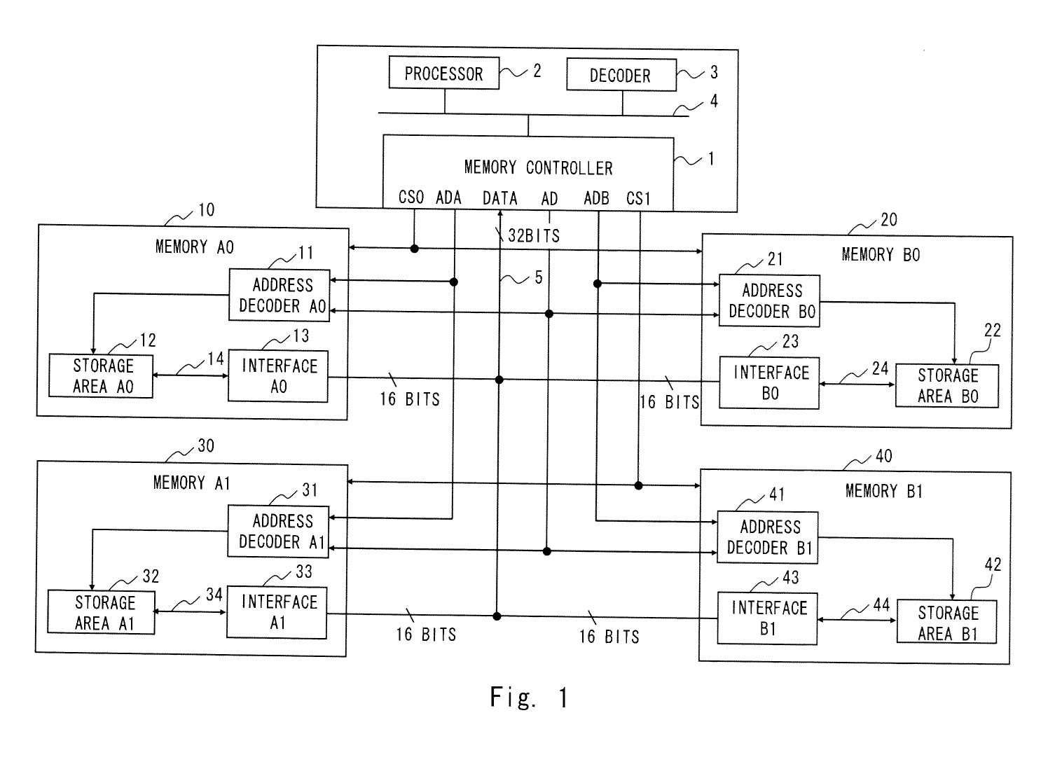

FIG. 1 is a block diagram showing a memory access system according to the embodiment. The memory access system shown in FIG. 1 includes a memory controller 1, a memory A0 (10: first memory), a memory B0 (20: second memory), a memory A1 (30: third memory), and a memory B1 (40: fourth memory). The memory controller 1 is connected to the memory A0 (10), the memory B0 (20), the memory A1 (30) and the memory B1 (40) and controls those memories. Further, a processor 2 and a decoder 3 are connected to the memory controller 1 through a common bus 4.

The memory controller 1 outputs a common address (AD) to the memory A0 (10), the memory B0 (20), the memory A1 (30) and the memory B1 (40). Further, the memory controller 1 outputs a first unique address (ADA) to the memory A0 (10) and the memory A1 (30). Further, the memory controller 1 outputs a second unique address (ADB) to the memory B0 (20) and the memory B1 (40). The first unique address (ADA) and the second unique address (ADB) can be controlled independently of each other. Further, the memory controller 1 outputs a first chip select signal (CS0) to the memory A0 (10), the memory B0 (20). Further, the memory controller 1 outputs a second chip select signal (CS1) to the memory A1 (30) and the memory B1 (40).

The memory A0 (10) includes an address decoder A0 (11), a storage area A0 (12), an interface A0 (13), and a bus 14. When the chip select signal CS0 is activated, the memory A0 (10) receives the common address (AD) and the first unique address (ADA) from the memory controller 1 by the address decoder A0 (11). Then, the memory A0 (10) outputs data stored in the storage area A0 (12) and corresponding to the common address (AD) and the first unique address (ADA) to the memory controller 1 through the bus 14 and the interface A0 (13).

The memory B0 (20) includes an address decoder B0 (21), a storage area B0 (22), an interface B0 (23), and a bus 24. When the chip select signal CS0 is activated, the memory B0 (20) receives the common address (AD) and the second unique address (ADB) from the memory controller 1 by the address decoder B0 (21). Then, the memory B0 (20) outputs data stored in the storage area B0 (22) and corresponding to the common address (AD) and the second unique address (ADB) to the memory controller 1 through the bus 24 and the interface B0 (23).

The memory A1 (30) includes an address decoder A1 (31), a storage area A1 (32), an interface A1 (33), and a bus 34. When the chip select signal CS1 is activated, the memory A1 (30) receives the common address (AD) and the first unique address (ADA) from the memory controller 1 by the address decoder A1 (31). Then, the memory A1 (30) outputs data stored in the storage area A1 (32) and corresponding to the common address (AD) and the first unique address (ADA) to the memory controller 1 through the bus 34 and the interface A1 (33).

The memory B1 (40) includes an address decoder B1 (41), a storage area B1 (42), an interface B1 (43), and a bus 44. When the chip select signal CS1 is activated, the memory B1 (40) receives the common address (AD) and the second unique address (ADB) from the memory controller 1 by the address decoder B1 (41). Then, the memory B1 (40) outputs data stored in the storage area B1 (42) and corresponding to the common address (AD) and the second unique address (ADB) to the memory controller 1 through the bus 44 and the interface B1 (43).

In this embodiment, the first unique address (ADA) and the second unique address (ADB) are both 2-bit signals. For example, the common address (AD[n:6, 3:0]) and the first unique address (ADA[5:4]) are supplied to the address decoder A0 (11). Further, the common address (AD[n:6, 3:0]) and the second unique address (ADB[5:4]) are supplied to the address decoder B0 (21), for example. Specifically, as the first unique address (ADA) and the second unique address (ADB), an address assigned to the fourth bit and the fifth bit may be used, for example. Note that the first unique address (ADA) and the second unique address (ADB) may be signals of two bits or more, and positions of bits may alternatively be the low-order two bits, for example.

Further, in this embodiment, the bit width of data output from the memory A0 (10), the memory B0 (20), the memory A1 (30) and the memory B1 (40) is 16 bits, and the bus width of a bus 5 through which those data merge is 32 bits, for example. Note that the bit width of data output from each memory and the bus width of the bus 5 may be changed according to the type of a memory in use.

Further, in the memory access system according to the embodiment, the memory A0 (10), the memory B0 (20), the memory A1 (30) and the memory B1 (40) have a function of disabling data input to themselves and a function of bringing data output of themselves to high impedance during a period when the corresponding chip select signal is not activated. By such functions, data from the activated one of the memory A0 (10) and the memory A1 (30) is output to the bus 5. Further, data from the activated one of the memory B0 (20) and the memory B1 (40) is output to the bus 5.

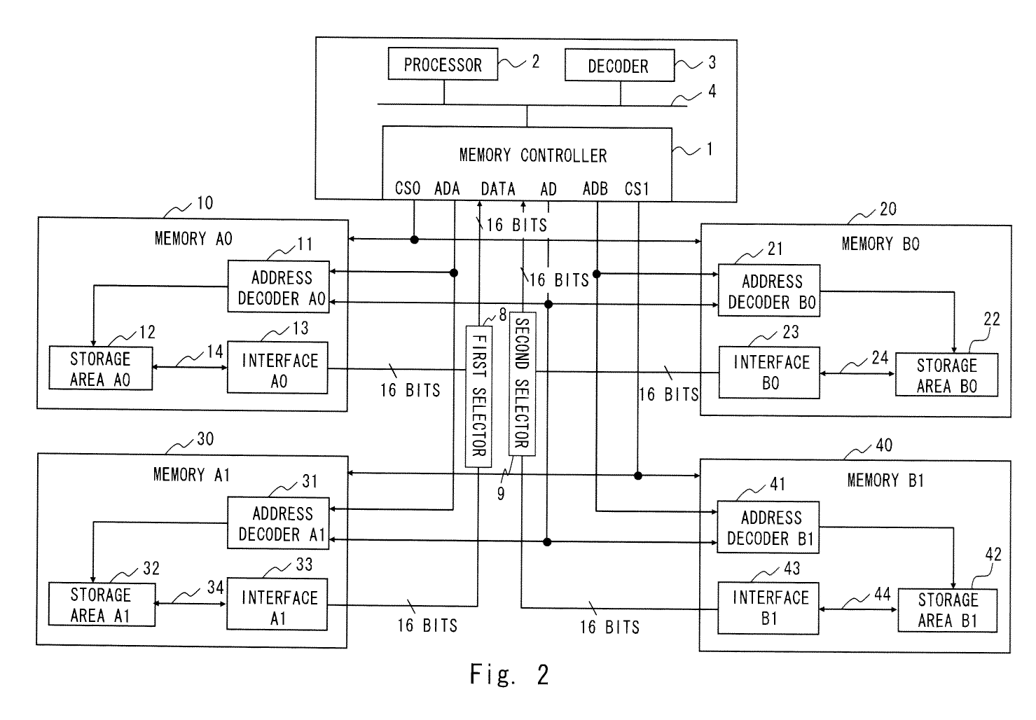

Note that the memory access system according to the embodiment may have a structure that further includes a first selector 8 and a second selector 9 as shown in FIG. 2, for example. The first selector 8 disables data input to one of the memory A0 (10) and the memory A1 (30) for which the chip select signal is not activated at the time of data writing and selects data output of one of the memory A0 (10) and the memory A1 (30) for which the chip select signal is activated at the time of data reading. Likewise, the second selector 9 disables data input to one of the memory B0 (20) and the memory B1 (40) for which the chip select signal is not activated at the time of data writing and selects data output of one of the memory B0 (20) and the memory B1 (40) for which the chip select signal is activated at the time of data reading.

Specifically, when the first chip select signal (CS0) is activated, the first selector 8 selects data output of the memory A0 (10), and the second selector 9 selects data output of the memory B0 (20). Likewise, when the second chip select signal (CS1) is activated, the first selector 8 selects data output of the memory A1 (30), and the second selector 9 selects data output of the memory B1 (40). Although the memory access system shown in FIG. 1 is described hereinbelow by way of illustration, the same applies to the memory access system shown in FIG. 2 except that it includes the first selector 8 and the second selector 9.

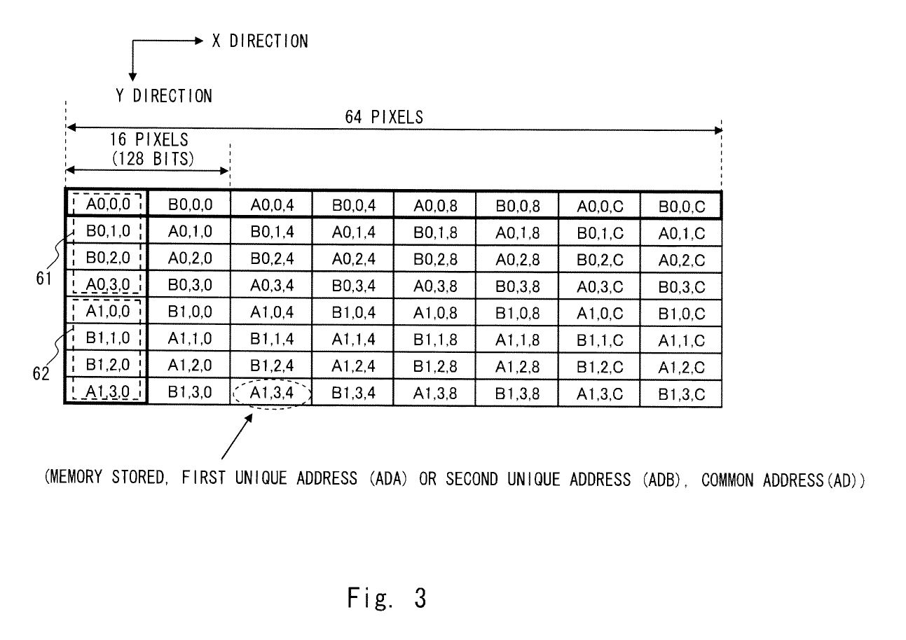

FIG. 3 is a view showing an example of mapping of two-dimensional array data to be accessed using the memory access system according to the embodiment into addresses of four memories, i.e., the memory A0 (10), the memory B0 (20), the memory A1 (30) and the memory B1 (40). In FIG. 3, one block is the substantial minimum access unit (16 bits×4 bursts=64 bits) of one memory and stores eight pixels of image data which are consecutive in the X direction.

In each block, information of the memory (A0/A1/B0/B1) stored, address information (2 bits) corresponding to the first unique address (ADA) or the second unique address (ADB), and information of low-order 6 bits (low-order 2 bits are fixed to 0 because access is made in four bursts) of the common address (hexadecimal number) of the memories are given. Specifically, it is shown that the block (A0,0,4) is stored in the memory “A0”, the first unique address (ADA) is “0” (this is ADA because it is stored in the memory A0), and the common address is “4”, for example.

Note that, although data with the common address “4”, “5”, “6” and “7” is stored in the block (A0,0,4), only the leading common address is shown in FIG. 3. Further, the block (B1, 3, 8), for example, is stored in the memory “B1”, the second unique address (ADB) is “3” (this is ADB because it is stored in the memory B1), and the common address is “8” (including data with the common address “9”, “A” and “B”).

In the memory access system according to the embodiment, data arranged in an array of 64 pixels (512 bits) in the X direction and 8 rows in the Y direction is a unit of storing two-dimensional array data. Note that when storing larger two-dimensional array data, a plurality of storing units (64 pixels×8 rows) are arranged in the X direction and the Y direction according to the data size.

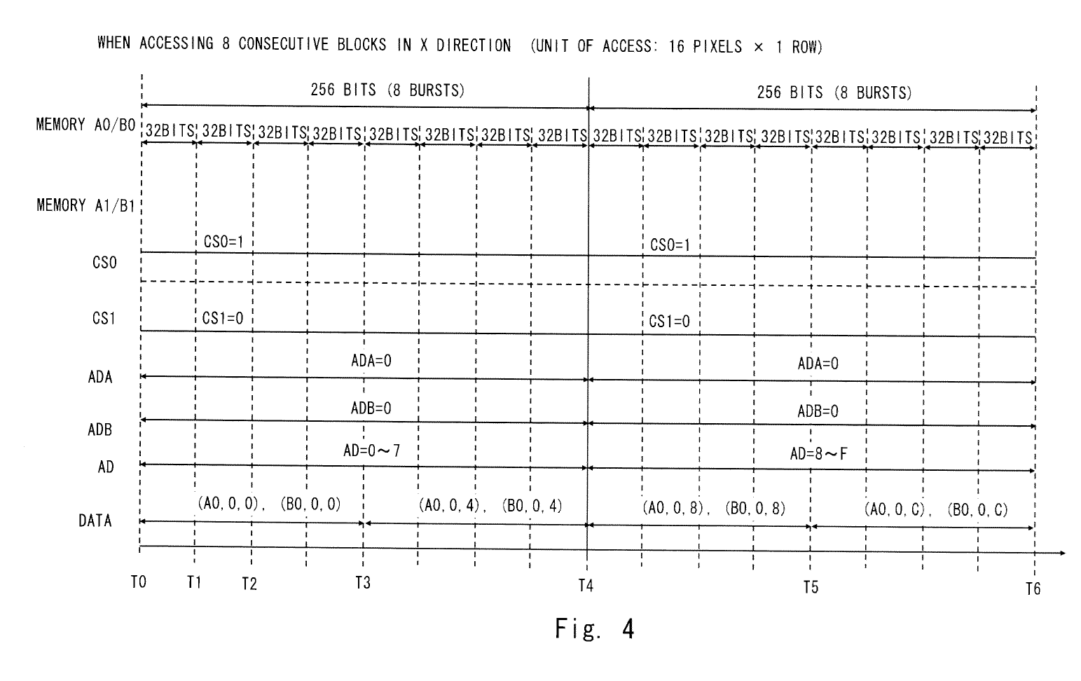

An operation of the memory access system according to the embodiment is described hereinafter. First, the operation in the case of accessing eight blocks in the X direction is described with reference to FIG. 4. In FIG. 4, the case of accessing eight blocks in the X direction in the first row of the mapping shown in FIG. 3 is described by way of illustration. Note that, although control signal and address signal input to the memory and data input/output of the memory occur at the same timing in FIG. 4 for simplification of description, the data input/output timing of the memory is usually delayed from the control signal and address signal input timing.

In the mapping shown in FIG. 3, the blocks arranged in the X direction are either a combination of A0 and B0 or a combination of A1 and B1. Specifically, mapping is performed so that the blocks arranged in the X direction are stored in the memory A0 (10) and the memory B0 (20) or stored in the memory A1 (30) and the memory B1 (40).

The combination of A0 and B0 is accessed when the first chip select signal (CS0) is activated (CS0=“1”), and the combination of A1 and B1 is accessed when the second chip select signal (CS1) is activated (CS1=“1”). Thus, the blocks arranged in the X direction are stored in the memories selected by the same chip select signal. In the example shown in FIG. 4, in order to access the data in the first row (the combination of A0 and B0) of the mapping shown in FIG. 3, the memory controller 1 outputs CS0=“1” and CS1=“0” to the memory A0 (10) and the memory B0 (20). The memory A0 (10) and the memory B0 (20) are thereby activated.

Further, in the mapping shown in FIG. 3, the first unique address (ADA) and the second unique address (ADB) of the blocks arranged in the X direction are the same. Thus, when accessing the data of the blocks arranged in the X direction, ADA=ADB. In the example shown in FIG. 4, in order to access the data in the first row of the mapping shown in FIG. 3, the memory controller 1 outputs the first unique address (ADA)=“0” to the memory A0 (10) and outputs the second unique address (ADB)=“0” to the memory B0 (20).

Furthermore, in the mapping shown in FIG. 3, the common addresses of the blocks arranged in the X direction and stored in the same memory are in ascending order. Specifically, in the mapping shown in FIG. 3, the common addresses of the blocks arranged in the X direction are in ascending order from 0 to F (hexadecimal number). Thus, the memory controller 1 outputs AD=0 to F as the common address (AD) to the memory A0 (10) and the memory B0 (20).

When accessing the blocks arranged in the X direction, because the common addresses of the respective blocks are in ascending order, the memory controller 1 can access the memory A0 (10) and the memory B0 (20) in eight bursts as shown in FIG. 4. In the memory access system shown in FIG. 1, 32-bit width data that combines 16-bit width data from the memory A0 (10) and 16-bit width data from the memory B0 (20) is output for eight clocks (eight burst length). Thus, as shown in FIG. 4, the memory A0 (10) and the memory B0 (20) output 256-bit data at T0 to T4 and output 256-bit data at T4 to T6 to the memory controller 1.

More specifically, at T0 to T1, data corresponding to AD=“0” out of the data of the block (A0, 0, 0) and the block (B0, 0, 0) is output, 16 bits from the memory A0 (10) and 16 bits from the memory B0 (20), so that data of 32 bits in total is output to the memory controller 1.

Likewise, at T1 to T2, data corresponding to AD=“1” out of the data of the block (A0, 0, 0) and the block (B0, 0, 0) is output, 16 bits from the memory A0 (10) and 16 bits from the memory B0 (20), so that data of 32 bits in total is output to the memory controller 1. This is the same for T2 and beyond.

As shown in FIG. 4, data of the block (A0, 0, 0) and the block (B0, 0, 0) is output at T0 to T3, data of the block (A0, 0, 4) and the block (B0, 0, 4) is output at T3 to T4, data of the block (A0, 0, 8) and the block (B0, 0, 8) is output at T4 to T5, and data of the block (A0, 0, C) and the block (B0, 0, C) is output at T5 to T6, respectively from the memory A0 (10) and the memory B0 (20) to the memory controller 1.

When the data is output from the memory A0 (10) and the memory B0 (20) to the memory controller 1, the data of the memory A0 (10) is output first and the data of the memory B0 (20) is output after that. Note that, in the mapping shown in FIG. 3, in the case of ADA=ADB=1 or 2, because the sequence of the data stored in the memory A0/A1 and the memory B0/B1 is reversed (i.e. which is in the sequence of B0/A0 and B1/A1) from that in the case of ADA=ADB=0 or 3, it is necessary to make swapping between the high-order 64 bits and the low-order 64 bits of the data. The swapping is performed in the memory controller 1, for example.

Next, the operation in the case of accessing blocks in eight consecutive rows in the Y direction is described. In this case, two-dimensional array data is mapped as shown in FIG. 3. Specifically, the mapping shown in FIG. 3 is such that the first and second unique addresses (ADA and ADB) of the respective blocks in a block group 61 (first block group) stored in the memory A0 (10) and the memory B0 (20) are different. In the mapping shown in FIG. 3, data is mapped so that the first and second unique addresses (ADA and ADB) are in ascending order (in the order of “0”, “1”, “2” and “3”) in the Y direction of the block group 61.

Further, the mapping shown in FIG. 3 is such that the first and second unique addresses (ADA and ADB) of the respective blocks in a block group 62 (second block group) stored in the memory A1 (30) and the memory B1 (40) coincide with the first and second unique addresses (ADA and ADB) of the respective blocks in the block group 61. In the mapping shown in FIG. 3, data is mapped so that the first and second unique addresses (ADA and ADB) are in ascending order (in the order of “0”, “1” “2” and “3”) in the Y direction of the block group 62.

Further, the common addresses (AD) of the blocks arranged in the Y direction are all “0”, which are the same.

Furthermore, the mapping shown in FIG. 3 is such that the blocks adjacent to each other among the blocks arranged in the Y direction are stored in the memory A0 (10) and the memory B0 (20) or stored in the memory A1 (30) and the memory B1 (40).

In the case of the mapping shown in FIG. 3, when CS0=“1”, access is made to the data of the first block group 61 (the blocks stored in the memory A0 (10) and the memory B0 (20)). Further, when CS1=“1”, access is made to the data of the second block group 62 (the blocks stored in the memory A1 (30) and the memory B1 (40)).

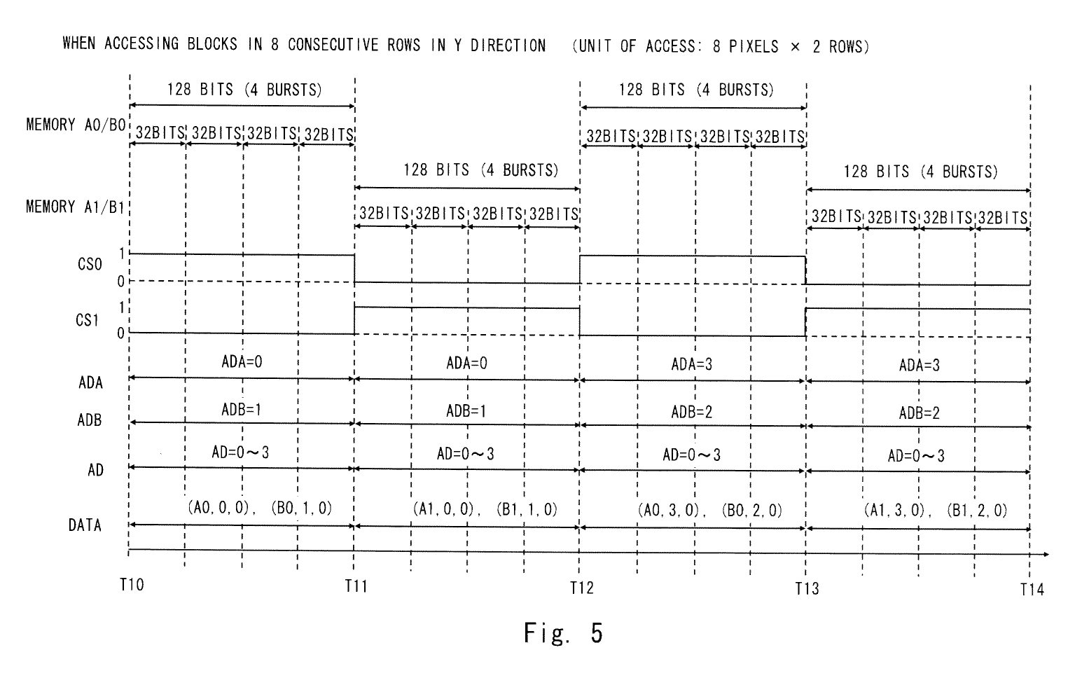

The operation in the case of accessing blocks in eight consecutive rows in the Y direction is described with reference to FIG. 5. In FIG. 5, the case of accessing eight blocks in the Y direction in the first column of the mapping shown in FIG. 3 is described by way of illustration.

As shown in FIG. 5, at T10 to T11 (first timing), the memory controller 1 outputs CS1=“1” and CS1=“0” to the respective memories. The memory A0 (10) and the memory B0 (20) are thereby activated, and the memory A1 (30) and the memory B1 (40) are thereby inactivated. Then, when the memory controller 1 outputs ADA=“0” and AD=“0 to 3” to the memory A0 (10) at T10 to T11, the memory A0 (10) outputs data of the block (A0, 0, 0) to the memory controller 1. Likewise, when the memory controller 1 outputs ADB=“1” (which is the address different from ADA) and AD=“0 to 3” to the memory B0 (20) at T10 to T11, the memory B0 (20) outputs data of the block (B0, 1, 0) to the memory controller 1. Note that the block (A0, 0, 0) and the block (B0, 1, 0) are blocks in the first block group 61.

Next, at T11 to T12 (second timing), the memory controller 1 outputs CS0=“0” and CS1=“1” to the respective memories. The memory A0 (10) and the memory B0 (20) are thereby inactivated, and the memory A1 (30) and the memory B1 (40) are thereby activated. Then, when the memory controller 1 outputs ADA=“0” and AD=“0 to 3” to the memory A1 (30) at T11 to T12, the memory A1 (30) outputs data of the block (A1, 0, 0) to the memory controller 1. Likewise, when the memory controller 1 outputs ADB=“1” (which is the address different from ADA) and AD=“0 to 3” to the memory B1 (40) at T11 to T12, the memory B1 (40) outputs data of the block (B1, 1, 0) to the memory controller 1. Note that the block (A1, 0, 0) and the block (B1, 1, 0) are blocks in the second block group 62. Further. ADA and ADB at this time are the same as ADA and ADB at T10 to T11.

Then, at T12 to 113 (third timing), the memory controller 1 outputs CS0=“1” and CS1=“0” to the respective memories. The memory A0 (10) and the memory B0 (20) are thereby activated, and the memory A1 (30) and the memory B1 (40) are thereby inactivated. Then, when the memory controller 1 outputs ADA=“3” and AD=“0 to 3” to the memory A0 (10) at T12 to T13, the memory A0 (10) outputs data of the block (A0, 3, 0) to the memory controller 1. Likewise, when the memory controller 1 outputs ADB=“2” (which is the address different from ADA) and AD=“0 to 3” to the memory B0 (20) at T12 to T13, the memory B0 (20) outputs data of the block (B0, 2, 0) to the memory controller 1. Note that the block (A0, 3, 0) and the block (B0, 2, 0) are blocks in the first block group 61.

Note that, as shown in FIG. 3, because the sequence of the data stored in the memory A0/B0 is reversed (i.e. in the sequence of B0/A0 in FIG. 3) in this case, swapping of the data of the block (A0, 3, 0) (high-order 64 bits) and the data of the block (B0, 2, 0) (low-order 64 bits) is necessary.

Next, at T13 to T14 (fourth timing), the memory controller 1 outputs CS0=“0” and CS1=“1” to the respective memories. The memory A0 (10) and the memory B0 (20) are thereby inactivated, and the memory A1 (30) and the memory B1 (40) are thereby activated. Then, when the memory controller 1 outputs ADA=“3” and AD=“0 to 3” to the memory A1 (30) at T13 to T14, the memory A1 (30) outputs data of the block (A1, 3, 0) to the memory controller 1. Likewise, when the memory controller 1 outputs ADB=“2” (which is the address different from ADA) and AD=“0 to 3” to the memory B1 (40) at T13 to T14, the memory B1 (40) outputs data of the block (B1, 2, 0) to the memory controller 1. Note that the block (A1, 3, 0) and the block (B1, 2, 0) are blocks in the second block group 62. Further, ADA and ADB at this time are the same as ADA and ADB at T12 to T13.

Note that, as shown in FIG. 3, because the sequence of the data stored in the memory A1/B1 is reversed (i.e. the sequence is B1/A1 in FIG. 3) in this case, swapping of the data of the block (A1, 3, 0) (high-order 64 bits) and the data of the block (B1, 2, 0) (low-order 64 bits) is necessary.

In this manner, the memory access system according to the embodiment performs access to the memory A0 (10) and the memory B0 (20) and access to the memory A1 (30) and the memory B1 (40) alternatively using the chip select signals (CS0, CS1), thereby enabling memory access in units of four bursts.

It should be noted that the operation of accessing eight blocks arranged in the Y direction described above is the same for the third column (the column having the block (A0, 0, 4)), the fifth column (the column having the block (A0, 0, 8)) and the seventh column (the column having the block (A0, 0, C)) of the mapping shown in FIG. 3.

Further, the operation in the case of accessing eight blocks in the Y direction in the second column of the mapping shown in FIG. 3 is as follows (the detailed operation is the same as that in the case of FIG. 5).

First, CS0=“1” is set to activate the memory A0 (10) and the memory B0 (20). Then, the memory controller 1 outputs ADA=“1”, ADB=“0” and AD=“0 to 3” to the memory A0 (10) and the memory B0 (20). Data of the block (A0, 1, 0) stored in the memory A0 (10) and data of the block (B0, 0, 0) stored in the memory B0 (20) are thereby read out. At this time, in the blocks in the second column of the mapping shown in FIG. 3, because the data of the block (A0, 1, 0) (high-order 64 bits) and the data of the block (B0, 0, 0) (low-order 64 bits) are reversed, swapping is necessary.

Next, CS1=“1” is set to activate the memory A1 (30) and the memory B1 (40). Then, the memory controller 1 outputs ADA=“1”, ADB=“0” and AD=“0 to 3” to the memory A1 (30) and the memory B1 (40). Data of the block (A1, 1, 0) stored in the memory A1 (30) and data of the block (B1, 0, 0) stored in the memory B1 (40) are thereby read out. At this time, in the blocks in the second column of the mapping shown in FIG. 3, because the data of the block (A1, 1, 0) (high-order 64 bits) and the data of the block (B1, 0, 0) (low-order 64 bits) are reversed, swapping is necessary.

Then, CS0=“1” is set to activate the memory A0 (10) and the memory B0 (20). Then, the memory controller 1 outputs ADA=“2”, ADB=“3” and AD=“0 to 3” to the memory A0 (10) and the memory B0 (20). Data of the block (A0, 2, 0) stored in the memory A0 (10) and data of the block (B0, 3, 0) stored in the memory B0 (20) are thereby read out.

After that, CS1=“1” is set to activate the memory A1 (30) and the memory B1 (40). Then, the memory controller 1 outputs ADA=“2”, ADB=“3” and AD=“0 to 3” to the memory A1 (30) and the memory B1 (40). Data of the block (A1, 2, 0) stored in the memory A1 (30) and data of the block (B1, 3, 0) stored in the memory B1 (40) are thereby read out.

It should be noted that the operation in the case of accessing eight blocks in the Y direction in the second column described above is the same for the fourth column (the column having the block (B0, 0, 4)), the sixth column (the column having the block (B0, 0, 8)) and the eighth column (the column having the block (B0, 0, C)) of the mapping shown in FIG. 3.

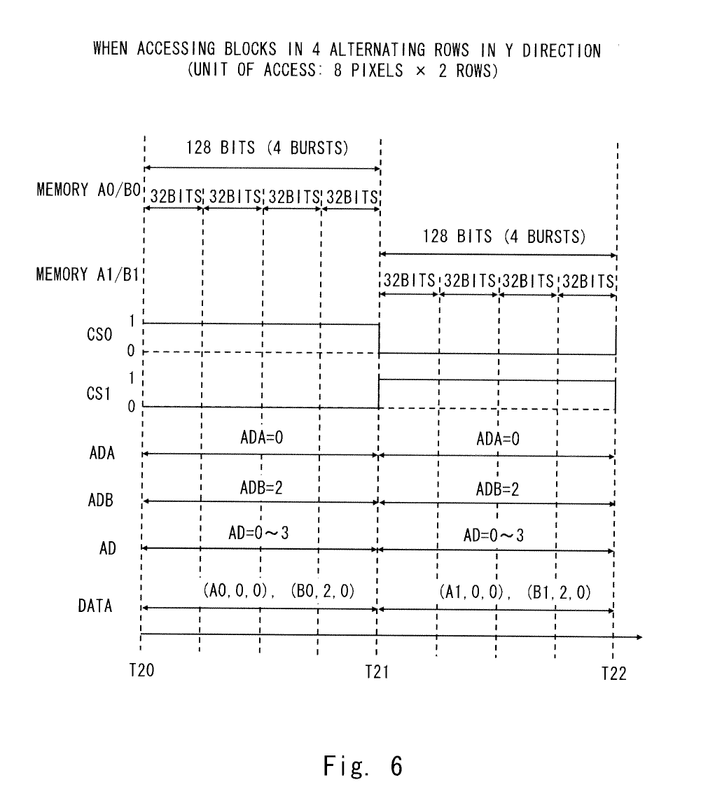

The operation in the case of accessing data of blocks in four alternating rows in the Y direction is described with reference to FIG. 6. In FIG. 6, the case of accessing four blocks in alternating rows in the Y direction in the first column of the mapping shown in FIG. 3 is described by way of illustration.

First, at T20 to T21, the memory controller 1 outputs CS0=“1” to activate the memory A0 (10) and the memory B0 (20). Then, the memory controller 1 outputs ADA=“0”, ADB=“2” and AD=“0 to 3” to the memory A0 (10) and the memory B0 (20). Data of the block (A0, 0, 0) stored in the memory A0 (10) and data of the block (B0, 2, 0) stored in the memory B0 (20) are thereby read out.

Then, at T21 to T22, the memory controller 1 outputs CS1=“1” to activate the memory A1 (30) and the memory B1 (40). Then, the memory controller 1 outputs ADA=“0”, ADB=“2” and AD=“0 to 3” to the memory A1 (30) and the memory B1 (40). Data of the block (A1, 0, 0) stored in the memory A1 (30) and data of the block (B1, 2, 0) stored in the memory B1 (40) are thereby read out.

By such operation, access can be made to data of the block (A0, 0, 0), the block (B0, 2, 0), the block (A1, 0, 0) and the block (B1, 2, 0) arranged in alternating rows in the Y direction.

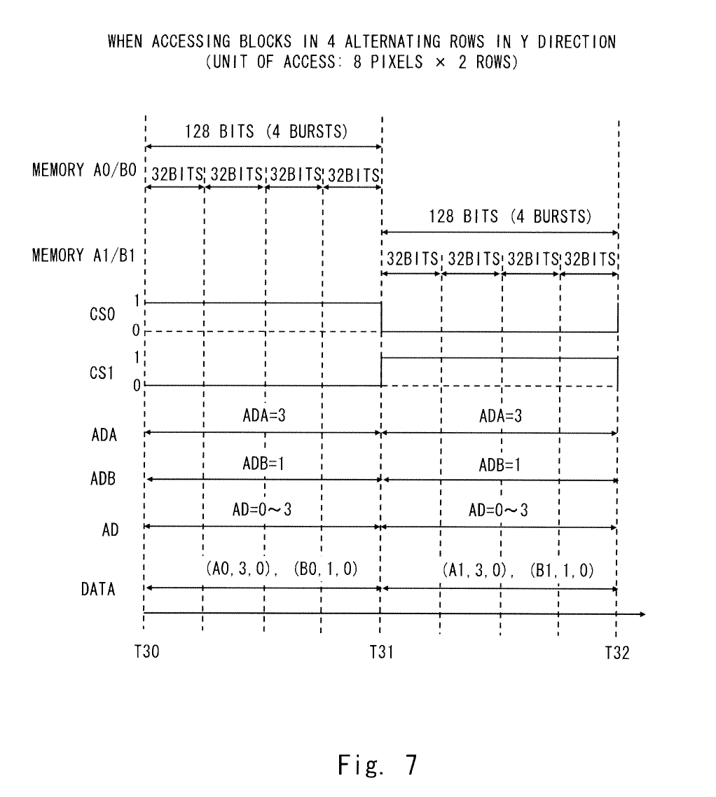

The operation in the case of accessing data of blocks in four alternating rows in the Y direction (the case of accessing data of blocks in different rows from the case of FIG. 6) is described with reference to FIG. 7. In FIG. 7 also, the case of accessing four blocks in alternating rows in the Y direction in the first column of the mapping shown in FIG. 3 is described by way of illustration.

First, at T30 to T31, the memory controller 1 outputs CS0=“1” to activate the memory A0 (10) and the memory B0 (20). Then, the memory controller 1 outputs ADA=“3”, ADB=“1” and AD=“0 to 3” to the memory A0 (10) and the memory B0 (20). Data of the block (A0, 3, 0) stored in the memory A0 (10) and data of the block (B0, 1, 0) stored in the memory B0 (20) are thereby read out. At this time, in the blocks in the first column of the mapping shown in FIG. 3, because the data of the block (A0, 3, 0) (high-order 64 bits) and the data of the block (B0, 1, 0) (low-order 64 bits) are reversed, swapping is necessary.

Then, at T31 to T32, the memory controller 1 outputs CS1=“1” to activate the memory A1 (30) and the memory B1 (40). Then, the memory controller 1 outputs ADA=“3”, ADB=“1” and AD=“0 to 3” to the memory A1 (30) and the memory B1 (40). Data of the block (A1, 3, 0) stored in the memory A1 (30) and data of the block (B1, 1, 0) stored in the memory B1 (40) are thereby read out. At this time, in the blocks in the first column of the mapping shown in FIG. 3, because the data of the block (A1, 3, 0) (high-order 64 bits) and the data of the block (B1, 1, 0) (low-order 64 bits) are reversed, swapping is necessary.

By such operation, access can be made to data of the block (B0, 1, 0), the block (A0, 3, 0), the block (B1, 1, 0) and the block (A1, 3, 0) arranged in alternating rows in the Y direction.

It should be noted that the operations in the case of accessing data of blocks in four alternating rows in the Y direction described above with reference to FIGS. 6 and 7 are the same for the third column (the column having the block (A0, 0, 4)), the fifth column (the column having the block (A0, 0, 8)) and the seventh column (the column having the block (A0, 0, C)) of the mapping shown in FIG. 3.

Further, the operation in the case of accessing data of blocks in four alternating rows in the Y direction in the second column of the mapping shown in FIG. 3 is as follows (the detailed operation is the same as that in the case of FIGS. 6 and 7).

First, the memory controller 1 outputs CS0=“1” to activate the memory A0 (10) and the memory B0 (20). Then, the memory controller 1 outputs ADA=“2”, ADB=“0” and AD=“0 to 3” to the memory A0 (10) and the memory B0 (20). Data of the block (A0, 2, 0) stored in the memory A0 (10) and data of the block (B0, 0, 0) stored in the memory B0 (20) are thereby read out. At this time, in the blocks in the second column of the mapping shown in FIG. 3, because the data of the block (A0, 2, 0) (high-order 64 bits) and the data of the block (B0, 0, 0) (low-order 64 bits) are reversed, swapping is necessary.

Then, the memory controller 1 outputs CS1=“1” to activate the memory A1 (30) and the memory B1 (40). Then, the memory controller 1 outputs ADA=“2”, ADB=“0” and AD=“0 to 3” to the memory A1 (30) and the memory B1 (40). Data of the block (A1, 2, 0) stored in the memory A1 (30) and data of the block (B1, 0, 0) stored in the memory B1 (40) are thereby read out. At this time, in the blocks in the second column of the mapping shown in FIG. 3, because the data of the block (A1, 2, 0) (high-order 64 bits) and the data of the block (B1, 0, 0) (low-order 64 bits) are reversed, swapping is necessary.

By such operation, access can be made to data of the block (B0, 0, 0), the block (A0, 2, 0), the block (B1, 0, 0) and the block (A1, 2, 0) arranged in alternating rows in the Y direction.

Furthermore, the operation in another example of the case of accessing data of blocks in four alternating rows in the Y direction in the second column of the mapping shown in FIG. 3 is described (the detailed operation is the same as that in the case of FIGS. 6 and 7).

First, the memory controller 1 outputs CS0=“1” to activate the memory A0 (10) and the memory B0 (20). Then, the memory controller 1 outputs ADA=“1”, ADB=“3” and AD=“0 to 3” to the memory A0 (10) and the memory B0 (20). Data of the block (A0, 1, 0) stored in the memory A0 (10) and data of the block (B0, 3, 0) stored in the memory B0 (20) are thereby read out.

Then, the memory controller 1 outputs CS1=“1” to activate the memory A1 (30) and the memory B1 (40). Then, the memory controller 1 outputs ADA=“1”, ADB=“3” and AD=“0 to 3” to the memory A1 (30) and the memory B1 (40). Data of the block (A1, 1, 0) stored in the memory A1 (30) and data of the block (B1, 3, 0) stored in the memory B1 (40) are thereby read out.

By such operation, access can be made to data of the block (A0, 1, 0), the block (B0, 3, 0), the block (A1, 1, 0) and the block (B1, 3, 0) arranged in alternating rows in the Y direction.

It should be noted that the operation in the case of accessing data of blocks in four alternating rows in the Y direction in the second column described above is the same for the fourth column (the column having the block (B0, 0, 4)), the sixth column (the column having the block (B0, 0, 8)) and the eighth column (the column having the block (B0, 0, C)) of the mapping shown in FIG. 3.

In the memory access system according to the embodiment, the memory controller 1 performs access to the memory A0 (10) and the memory B0 (20) and access to the memory A1 (30) and the memory B1 (40) alternatively using the chip select signals (CS0, CS1), thereby enabling memory access in units of four bursts, which are half the original burst length of the memory. Further, two-dimensional array data is mapped as shown in FIG. 3, so that access can be made to the blocks in the same column when each chip select signal (CS0, CS1) is activated, thereby enabling efficient access to the two-dimensional array data. Specifically, the blocks arranged in the memory A0 (10) and the memory B0 (20) which are selected when CS0=“1” and the blocks arranged in the memory A1 (30) and the memory B1 (40) which are selected when CS1=“1” are arranged in the same column, thereby enabling efficient access to the two-dimensional array data.

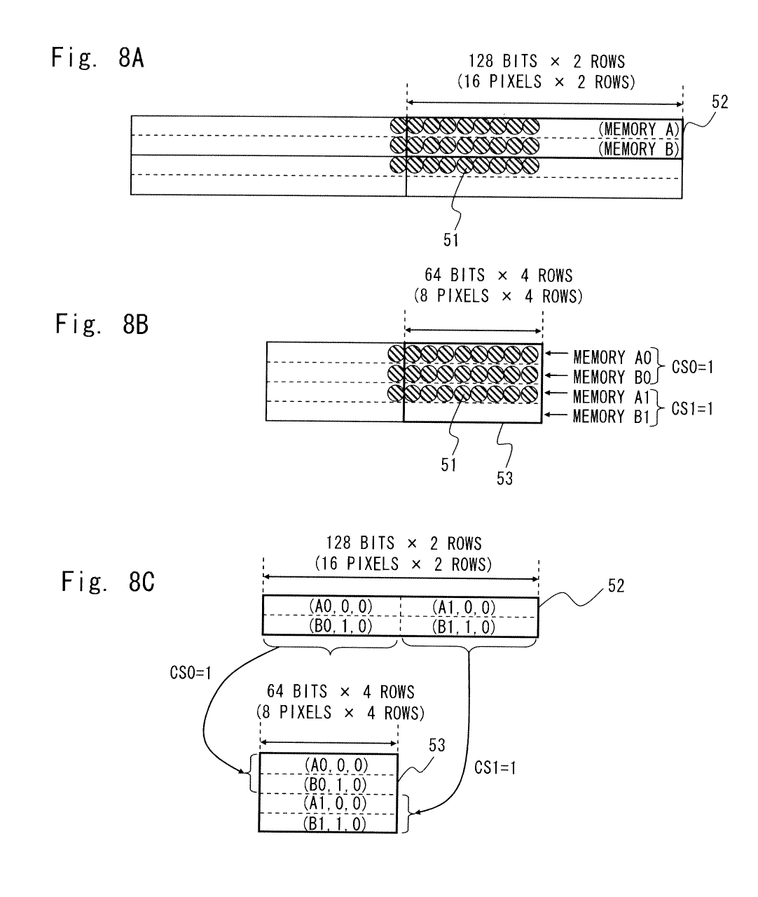

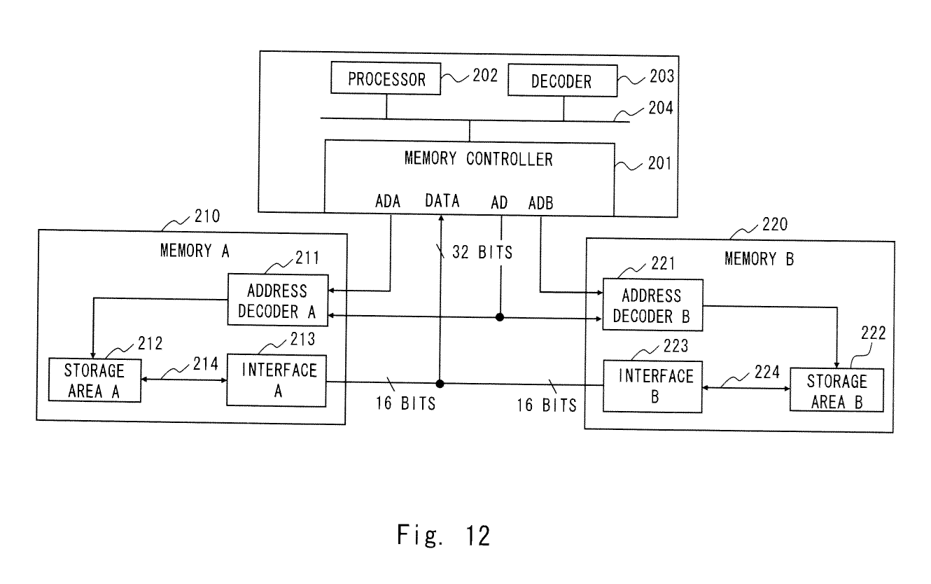

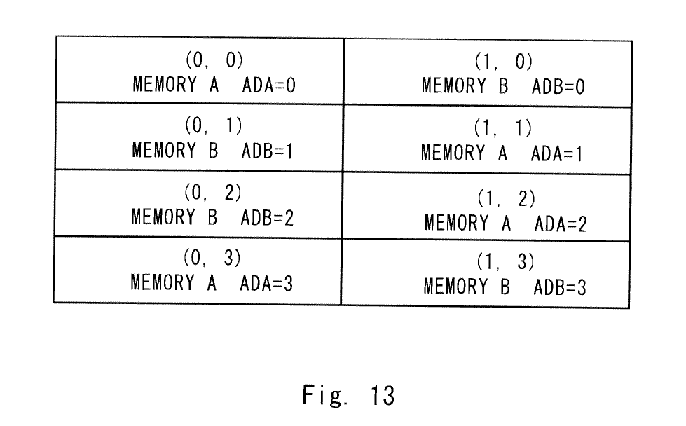

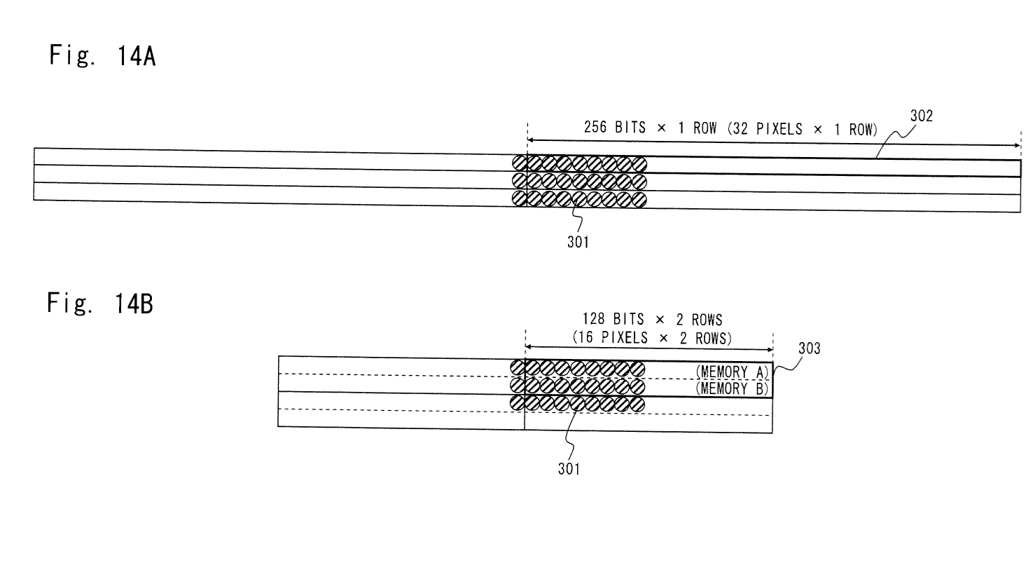

FIGS. 8A and 8B are views to make comparison between the case of accessing two-dimensional array image data using the memory access system according to the embodiment and the case of accessing two-dimensional array image data using the memory access system shown in FIG. 12. FIG. 8A shows the case of accessing image data in a two-dimensional array using the memory access system shown in FIG. 12. FIG. 8B shows the case of accessing image data in a two-dimensional array using the memory access system according to the embodiment. Further, FIG. 8C is a view to explain the principle of operation of the memory access system according to the embodiment. In FIGS. 8A to 8C, minimum access units 52 and 53 are 256 bits, which correspond to 32 pixels. Further, two-dimensional array image data 51 is 9 pixels×3 rows.

Referring to FIG. 8A, in the memory access system shown in FIG. 12, 128 bits×2 rows (16 pixels×2 rows) is the minimum access unit 52. Specifically, data in the first row of the two-dimensional array image data 51 is stored in the first row of the minimum access unit 52, and data in the second row of the two-dimensional array image data 51 is stored in the second row of the minimum access unit 52. Therefore, memory access when accessing the two-dimensional array image data 51 of 9 pixels×3 rows is 256 bits×4 times=1024 bits in total.

On the other hand, referring to FIG. 8B, in the memory access system according to the embodiment, 64 bits×4 rows (8 pixels×4 rows) is the minimum access unit 53. Specifically, data in the first row of the two-dimensional array image data 51 is stored in the memory A0 (10), the second row thereof is stored in the memory B0 (20), the third row thereof is stored in the memory A1 (30), and the fourth row thereof is stored in the memory B1 (40). At this time, the data stored in the memory A0 (10) and the memory B0 (20) is accessed at the timing of CS0=“1” (cf. T10 to T11 in FIG. 5). Further, the data stored in the memory A1 (30) and the memory B1 (40) is accessed at the timing of CS1=“1” (cf. T11 to T12 in FIG. 5). Therefore, in the memory access system according to the embodiment, memory access when accessing the two-dimensional array image data 51 of 9 pixels×3 rows is 128 bits×4 times=512 bits in total. Accordingly, use of the memory access system according to the embodiment enables reduction of the unit of memory access and improvement of the efficiency of memory access.

In the memory access system shown in FIG. 12, data of the block (A0, 0, 0) and data of the block (A1, 0, 0) are stored in the first row of the minimum access unit 52, and data of the block (B0, 1, 0) and data of the block (B1, 1, 0) are stored in the second row of the minimum access unit 52 as shown in FIG. 8C, for example. Then, access is made to the data of the minimum access unit 52 in eight burst length.

On the other hand, in the memory access system according to the embodiment, using the chip select signal (CS0, CS1), access is made to data of the block (A0, 0, 0) stored in the memory A0 (10) and data of the block (B0, 1, 0) stored in the memory B0 (20) when CS0=“1”. Further, access is made to data of the block (A1, 0, 0) stored in the memory A1 (30) and data of the block (B1, 1, 0) stored in the memory B1 (40) when CS1=“1”. Thus, in the memory access system according to the embodiment, 4-burst access can be made when the chip select signal is CS0=“1” or CS1=“1”, and the minimum access unit 53 can be 64 bits×4 rows (8 pixels×4 rows).

Note that, in the memory access system according to the embodiment, 8-burst access is performed when accessing eight consecutive blocks in the X direction, and 4-burst access is performed when accessing blocks in eight consecutive rows in the Y direction and when accessing blocks in four alternating rows in the Y direction. Specifically, in the memory access system according to the embodiment, the burst length when accessing blocks arranged in the Y direction is half the burst length when accessing blocks arranged in the X direction. In this manner, the memory access system according to the embodiment allows selection between 8-burst access and 4-burst access with use of the chip select signal (CS0, CS1).

As described above, according to the embodiment of the present invention, the memory access system and the memory access control method with high access efficiency can be provided. Further, use of the memory access system according to the embodiment enables suppression of access to unnecessary data other than desired data at the same time. Therefore, when the memory controller 1 outputs data to the decoder 3 through the common bus 4, for example, it is possible to prevent unnecessary data from occupying the common bus 4, thereby improving the efficiency of the system as a whole.

### Second Embodiment

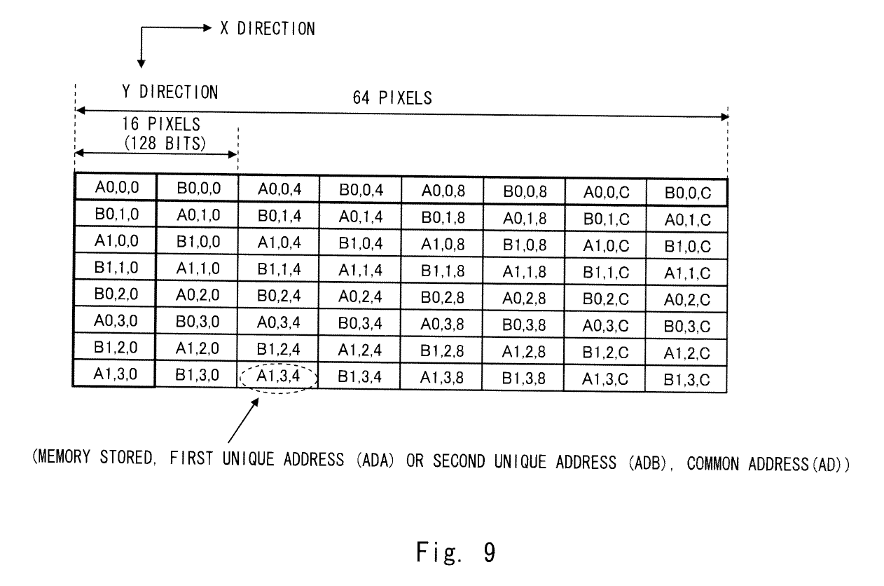

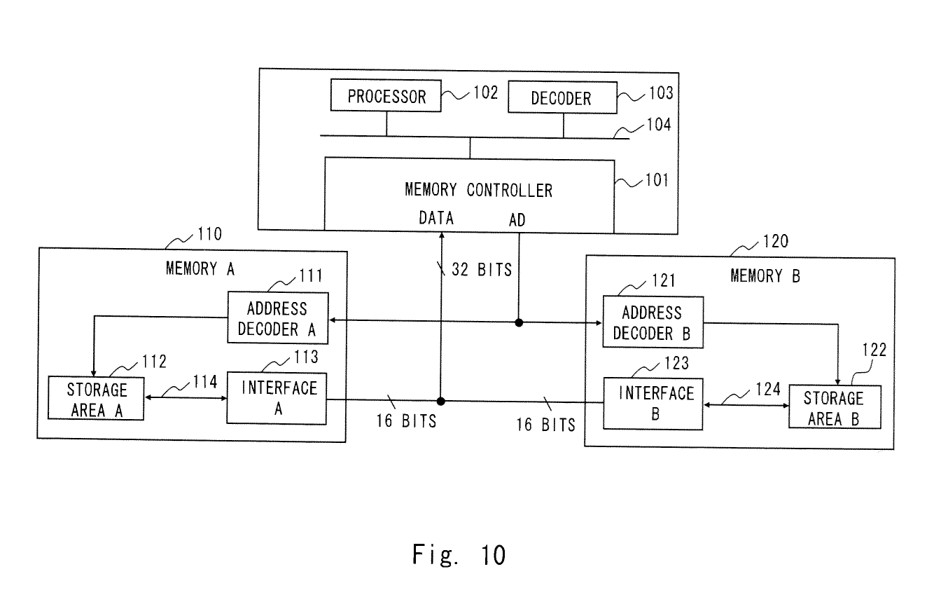

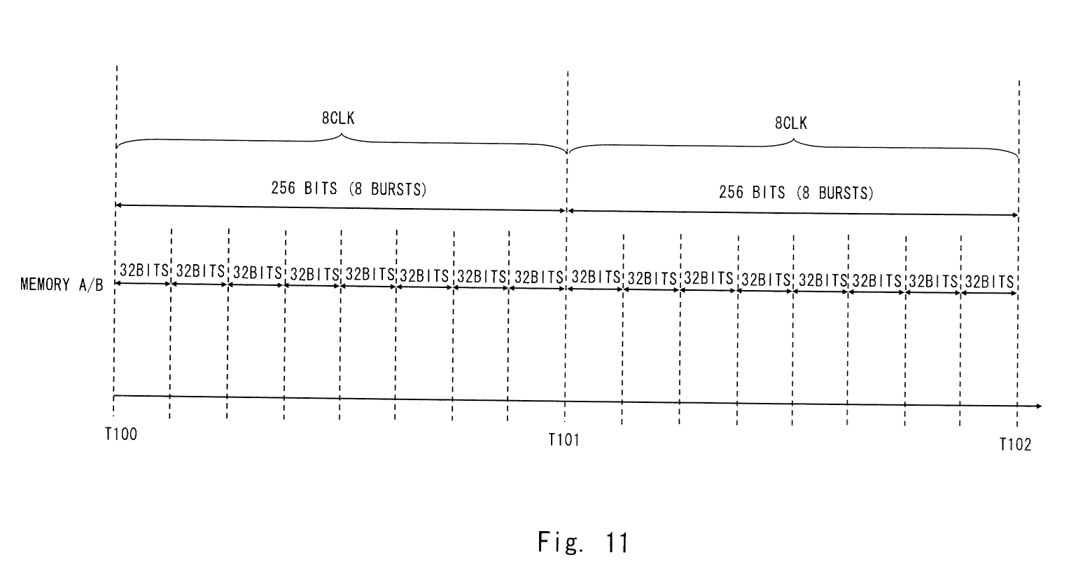

A second embodiment of the present invention is described hereinafter. FIG. 9 is a view showing mapping of two-dimensional array data to be accessed by the memory access system according to the embodiment. Note that the memory access system used in this embodiment is the same as the memory access system shown in FIG. 1 described in the first embodiment, and redundant explanation is omitted.

In the mapping shown in FIG. 9, the third row (the row having the block (B0, 2, 0)) and the fourth row (the row having the block (A0, 3, 0)) of the mapping shown in FIG. 3 are shifted after the sixth row (the having with the block (B1, 1, 0)) thereof.

Further, the operation when accessing eight blocks in the X direction is the same as that of the case described in the first embodiment (cf. FIG. 4). Further, the operation when accessing blocks in eight consecutive rows in the Y direction is also the same as that of the case described in the first embodiment (cf. FIG. 5). Furthermore, the operation when accessing blocks in four alternating rows in the Y direction is also the same as that of the case described in the first embodiment (cf. FIGS. 6 and 7).

In the operation of the memory access system according to the first embodiment, access is made to the blocks in the first to fourth row in FIG. 3 when CS=“0” and to the blocks in the fifth to eighth rows in FIG. 3 when CS=“1”. However, in the operation of the memory access system according to this embodiment, access is made to the blocks (the first block group) in the first, second, fifth and sixth rows in FIG. 9 when CS=“0”, and to the blocks (the second block group) in the third, fourth, seventh and eighth rows in FIG. 9 when CS=“1”. The operation except for this point is the same as that of the first embodiment

According to the embodiment of the present invention as well, the memory access system and the memory access control method with high access efficiency can be provided.

It should be noted that, the present invention is also applicable to the memory that is divided internally into two groups by addresses and that can be accessed with a burst length which is half the original length without degrading the efficiency other than when access is made consecutively in the same group. In the case of applying the present invention to such memory, two memory devices, a memory A connected to low-order 16 bits and a memory B connected to high-order 16 bits, are used (and a single chip select signal is used). In this case, the memory A0/B0 corresponds to a group 0 of the memory A/B, and the memory A1/B1 corresponds to a group 1 of the memory A/B, and CS0/CS1 is an address bit designating the group. Further, the present invention is also applicable to the memory that is divided into a given number (which is a power of two and greater than two) of groups by regarding an arbitrary one bit among the address bit designating the group as CS0/CS1.

The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A memory access system comprising:
first to fourth memories that store two-dimensional array data in units of blocks being a minimum access unit; and
a memory controller that controls access to the memories, wherein
the memory controller supplies a first chip select signal to the first and second memories, supplies a second chip select signal to the third and fourth memories, supplies a first unique address to the first and third memories, supplies a second unique address to the second and fourth memories, and supplies a common address to the first to fourth memories,
the two-dimensional array data is mapped in a given unit of storage, so that the first and second unique addresses of blocks arranged in an X direction are the same, the first and second unique addresses of respective blocks in a first block group arranged in a Y direction and stored in the first and second memories are different from each other, and the first and second unique addresses of respective blocks in a second block group arranged in the Y direction and stored in the third and fourth memories correspond to the first and second unique addresses of the respective blocks in the first block group, and that common addresses of respective blocks in the first and second block groups are the same, and
the memory controller accesses blocks in the first block group by supplying the first and second unique addresses different from each other at a first timing of activating the first chip select signal, and accesses blocks in the second block group by supplying the first and second unique addresses different from each other at a second timing of activating the second chip select signal.

2. The memory access system according to claim 1, wherein the two-dimensional array data is mapped so that blocks adjacent to each other among the blocks arranged in the Y direction are respectively stored in the first and second memories or stored in the third and fourth memories.

3. The memory access system according to claim 1, wherein the first and second unique addresses supplied from the memory controller at the first timing are the same as the first and second unique addresses supplied from the memory controller at the second timing.

4. The memory access system according to claim 1, wherein the memory controller further accesses blocks in the first block group different from the blocks accessed at the first timing by supplying the first and second unique addresses different from the first and second unique addresses supplied at the first timing and different from each other at a third timing of activating the first chip select signal, and accesses blocks in the second block group different from the blocks accessed at the second timing by supplying the first and second unique addresses different from the first and second unique addresses supplied at the second timing and different from each other at a fourth timing of activating the second chip select signal.

5. The memory access system according to claim 1, wherein the two-dimensional array data is mapped so that the blocks arranged in the X direction are respectively stored in the first and second memories or stored in the third and fourth memories.

6. The memory access system according to claim 1, wherein the two-dimensional array data is mapped so that the common addresses of blocks stored in the same memory among the blocks arranged in the X direction are in ascending order.

7. The memory access system according to claim 1, wherein the memory controller accesses the first to fourth memories so that a burst length when accessing the blocks arranged in the Y direction is half a burst length when accessing the blocks arranged in the X direction.

8. The memory access system according to claim 1, wherein the memory controller further includes:
a first selector that selects one of data output of the first memory and data output of the third memory according to the first and second chip select signals; and
a second selector that selects one of data output of the second memory and data output of the fourth memory according to the first and second chip select signals.

9. The memory access system according to claim 8, wherein
at the first timing of activating the first chip select signal, the first selector selects data output of the first memory, and the second selector selects data output of the second memory and
at the second timing of activating the second chip select signal, the first selector selects data output of the third memory, and the second selector selects data output of the fourth memory.

10. The memory access system according to claim 1, wherein
the two-dimensional array data in the given unit of storage is mapped so that, in the Y direction, a block in a first row is stored in the first memory, a block in a second row is stored in the second memory, a block in a third row is stored in the second memory, a block in a fourth row is stored in the first memory, and the first and second unique addresses are in ascending order in a sequence from the first row to the fourth row, and that, in the Y direction, a block in a fifth row is stored in the third memory, a block in a sixth row is stored in the fourth memory, a block in a seventh row is stored in the fourth memory, a block in an eighth row is stored in the third memory, and the first and second unique addresses are in ascending order in a sequence from the fifth row to the eighth row, and
the blocks in the first row to the fourth row form the first block group, and the blocks in the fifth row to the eighth row form the second block group.

11. The memory access system according to claim 1, wherein
the two-dimensional array data in the given unit of storage is mapped so that, in the Y direction, a block in a first row is stored in the second memory, a block in a second row is stored in the first memory, a block in a third row is stored in the first memory, a block in a fourth row is stored in the second memory, and the first and second unique addresses are in ascending order in a sequence from the first row to the fourth row, and that, in the Y direction, a block in a fifth row is stored in the fourth memory a block in a sixth row is stored in the third memory, a block in a seventh row is stored in the third memory, a block in an eighth row is stored in the fourth memory, and the first and second unique addresses are in ascending order in a sequence, from the fifth row to the eighth row, and
the blocks in the first row to the fourth row form the first block group, and the blocks in the fifth row to the eighth row form the second block group.

12. The memory access system according to claim 1, wherein
the two-dimensional array data in the given unit of storage is mapped so that, in the Y direction, a block in a first row is stored in the first memory, a block in a second row is stored in the second memory, a block in a fifth row is stored in the second memory, a block in a sixth row is stored in the first memory, and the first and second unique addresses are in ascending order in a sequence of the first row, the second row, the fifth row and the sixth row, and that, in the Y direction, a block in a third row is stored in the third memory, a block in a fourth row is stored in the fourth memory, a block in a seventh row is stored in the fourth memory, a block in an eighth row is stored in the third memory, and the first and second unique addresses are in ascending order in a sequence of the third row, the fourth row, the seventh row and the eighth row, and
the blocks in the first row, the second row, the fifth row and the sixth row form the first block group, and the blocks in the third row, the fourth row, the seventh row and the eighth row form the second block group.

13. The memory access system according to claim 1, wherein
the two-dimensional array data in the given unit of storage is mapped so that, in the Y direction, a block in a first row is stored in the second memory, a block in a second row is stored in the first memory, a block in a fifth row is stored in the first memory, a block in a sixth row is stored in the second memory, and the first and second unique addresses are in ascending order in a sequence of the first row, the second row, the fifth row and the sixth row, and that, in the Y direction, a block in a third row is stored in the fourth memory, a block in a fourth row is stored in the third memory, a block in a seventh row is stored in the third memory, a block in an eighth row is stored in the fourth memory, and the first and second unique addresses are in ascending order in a sequence of the third row, the fourth row, the seventh row and the eighth row, and
the blocks in the first row, the second row, the fifth row and the sixth row form the first block group, and the blocks in the third row, the fourth row, the seventh row and the eighth row form the second block group.

14. A memory access control method for accessing first to fourth memories storing two-dimensional array data in units of blocks being a minimum access unit, the method comprising:
supplying a first chip select signal to the first and second memories, supplying a second chip select signal to the third and fourth memories, supplying a first unique address to the first and third memories, supplying a second unique address to the second and fourth memories, and supplying a common address to the first to fourth memories;
mapping the two-dimensional array data in a given unit of storage, so that the first and second unique addresses of blocks arranged in an X direction are the same, the first and second unique addresses of respective blocks in a first block group arranged in a Y direction and stored in the first and second memories are different from each other, and the first and second unique addresses of respective blocks in a second block group arranged in the Y direction and stored in the third and fourth memories correspond to the first and second unique addresses of the respective blocks in the first block group, and that common addresses of respective blocks in the first and second block groups are the same;
accessing blocks in the first block group by supplying the first and second unique addresses different from each other at a first timing of activating the first chip select signal; and
accessing blocks in the second block group by supplying the first and second unique addresses different from each other at a second timing of activating the second chip select signal.

15. The memory access control method according to claim 14, comprising:
mapping the two-dimensional array data so that blocks adjacent to each other among the blocks arranged in the Y direction are respectively stored in the first and second memories or stored in the third and fourth memories.

16. The memory access control method according to claim 14, wherein the first and second unique addresses supplied at the first timing are the same as the first and second unique addresses supplied at the second timing.

17. The memory access control method according to claim 14, further comprising:
accessing blocks in the first block group different from the blocks accessed at the first timing by supplying the first and second unique addresses different from the first and second unique addresses supplied at the first timing and different from each other at a third timing of activating the first chip select signal; and
accessing blocks in the second block group different from the blocks accessed at the second timing by supplying the first and second unique addresses different from the first and second unique addresses supplied at the second timing and different from each other at a fourth timing of activating the second chip select signal.

18. The memory access control method according to claim 14, comprising:
mapping the two-dimensional array data so that the blocks arranged in the X direction are respectively stored in the first and second memories or stored in the third and fourth memories.

19. The memory access control method according to claim 14, comprising:
mapping the two-dimensional array data so that the common addresses of blocks stored in the same memory among the blocks arranged in the X direction are in ascending order.

20. The memory access control method according to claim 14, comprising:
accessing the first to fourth memories so that a burst length when accessing the blocks arranged in the Y direction is half a burst length when accessing the blocks arranged in the X direction.
